(19) United States
(12) Patent Application Publication
(10) Pub. No.: US 2009/0205101 A1
(43) Pub. Date: Aug. 20, 2009

(54) Shirt with Reinforced Front

(76) Inventor: William C. Vereen, Thomasville, GA (US)

Correspondence Address: SMITH, GAMBRELL & RUSSELL, SUITE 3100, PROMENADE II, 1230 PEACHTREE STREET, N.E., ATLANTA, GA, 30309-3592, US

(21) Appl. No.: 12/433,352

(22) Filed: Apr. 30, 2009

Related U.S. Application Data
(62) Division of application No. 11/118,888, filed on May 2, 2005.

(51) Int. Cl. A62B 17/00; A41B 1/00

(52) U.S. Cl. 2/81; 2/115

(57) ABSTRACT

A shirt is described that uses a double layer of fabric, strategically located across its front to protect the torso of the wearer.

### FIELD OF THE INVENTION

This invention is directed to a shirt having a front that is reinforced to protect the torso of the wearer.

### BACKGROUND OF THE INVENTION

Workers in many industries may be subjected to sudden thermal flashes directly in front of them. Electrical workers, for example, may experience an electric arc of great thermal intensity. This is particularly damaging to female workers because their brassieres may ignite outright, or the fabric and underwire melt or burn, causing severe injury. The traditional market solution has been to require that female employees exposed to these types of danger wear a brassiere made of a flame resistant fabric. This solution had its problems for the employer because such brassieres are expensive and are often difficult to fit and procure. There are also problems for the female employee in that such brassieres are made from a fabric having flame resistant fibers, which fabric is heavier than the female employee's regular brassiere fabric, and is somewhat stiff, uncomfortable and cumbersome.

Rather than focusing on the brassiere, the present invention is directed to providing the necessary protection for the employee by using a double layer of fabric strategically located across the front of the shirt. The double layers of fabric are significantly more protective than a single layer.

The double fabric layer is applied only in the front panels of the shirt for reasons, including the following:
1. Accidents involving electric arcs in work situations generally occur while the affected employee is working with his or her hands on a given task, and therefore generally occur in front of the affected employee. Infrared energy is the primary heat energy from an electric arc. It travels in a straight line and generally does not affect the back of a garment.
2. Most employees wear arc-rated gloves that extend to the elbow and are often also wearing full rubber sleeves that start at the wrists and go to the top of the shoulder (held in place with a strap that buckles around the back of the shoulders). This leaves a zone from the chest to the abdomen where a flame resistant shirt is the primary means of protection. The rubber sleeves and gloves are generally worn over a long sleeve flame resistant shirt or jacket. The gloves and sleeves have ATPVs that range from 25-100 calories square centimeter. Accordingly, the shirt needs little protection in the sleeve area if gloves and rubber sleeves are being utilized. For this reason, the main purpose for long sleeves in this application is for comfort under the heavy rubber. Lighter materials are the best for this purpose. Since the invention limits shirt construction to a double layer on the front panels only, the sleeves of the invented design are comprised of a single layer of fabric. The resulting thinness of the sleeves allows greater dexterity and the single layer construction of both the sleeves and rear of the shirt allow the employee's rear shoulder and back to ventilate heat and reduce the risk associated with heat build-up.
3. Typical shirts have an ATPV between 4.2-5.6 calories square centimeter. The highest scoring shirts that are presently commercially available are made from a flame resistant fabric known as Indura Ultra Soft® weighing 7.0 ounce per square yard. This fabric is desirable because it has an ATPV of 8.2 calories per square centimeter. The main reason that shirts manufactured from this fabric are not the industry's only choice is because they are heavy and hot. Heavier clothing traps heat and can result in excessive perspiration, (which can conduct electricity) heat exhaustion, heat stroke or other serious medical conditions which can affect the employee's judgment and dexterity on the job.

Construction of shirts with double layers of frontal shirt fabric yields greatly increased protection in the chest/abdomen area with greater breathe-ability and reduced heat retention. It provides the manufacturer the ability to use double layers of lighter material in the front panels and one light layer everywhere else, instead of using a heavier-weight flame resistant fabric to construct the entire shirt.

The present invention allows easier enforcement of flame resistant uniform policies, which can be problematic for the employer for both male and female employees. Is the female employee wearing a Nomex IIIA® brassiere or the male employee wearing a 100% cotton undershirt? The invention's double ply construction provides equal or better protection and will have a distinctive front insignia to allow an employer to readily determine that the employee is compliant with the employer's uniform requirements.

The benefits of this type of construction extend to numerous other applications and the present application is in no way intended to be limited solely to shirts for female employees, nor solely to the type of sewing construction utilized in the attached drawings as being the definitive means of construction. By way of example, the drawings illustrate a construction that includes the entire front panel, however because of cost or in an effort to further reduce heat retention, a customer might direct that the design be altered to utilize the double ply front panel construction above the belt line and a single ply construction on that part of the shirt that is to be tucked into the pants. Also, in some cases it may be desirable to provide double layers in other areas.

### DISCLOSURE OF THE PRIOR ART

Applicant is aware of no prior art directly relevant to the present invention.

### BRIEF DESCRIPTION OF THE DRAWINGS

FIG. 1 is a front perspective view illustrating a shirt embodying the present invention.

FIG. 2 is a detail view from the inside of a section of the shirt at point A of FIG. 1

FIG. 3 is a detail view from the inside of a section of the shirt at point B of FIG. 1

FIG. 4 is a front perspective view illustrating an alternate shirt embodying the present invention

FIG. 5 is a detail view from the outside of a section of the shirt at point A of FIG. 4

FIG. 6 is a detail view from the outside of a section of the shirt at point B of FIG. 4

### SUMMARY OF THE INVENTION

In accordance with the present invention a shirt is provided that greatly increases the frontal resistance to the thermal effects of an electric arc with a minimum increase in weight by strategically applying a second ply of fabric in the front of a shirt.

### DETAILED DESCRIPTION OF THE DRAWINGS

Reference will now be made to the preferred embodiments of the invention and illustrated in the drawings.

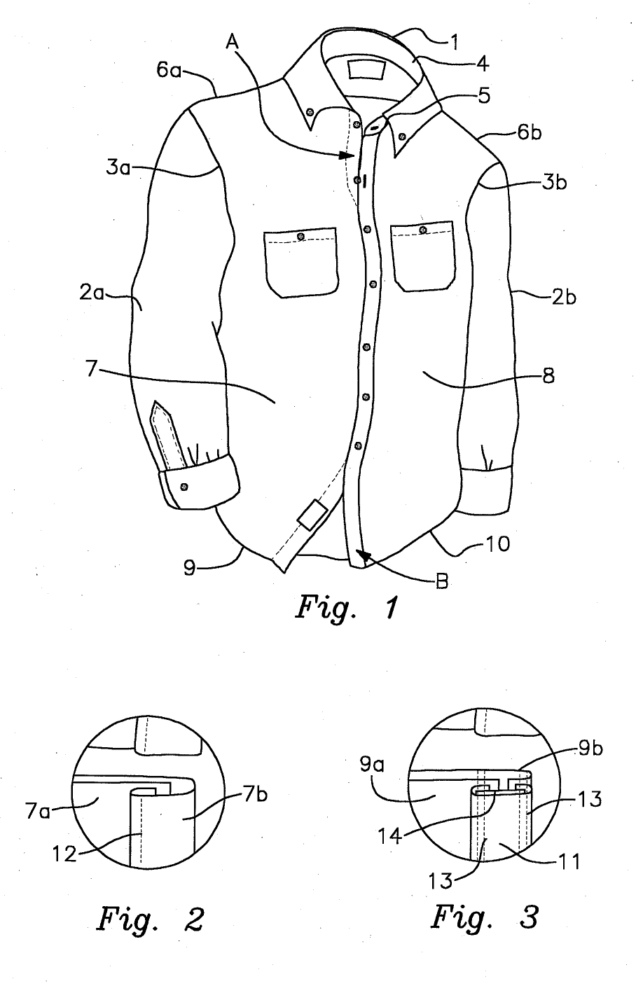

In FIG. 1, a shirt 1 comprises sleeves 2a and 2b, which extend from armholes 3a and 3b. There is a collar 4 formed above the neck opening 5. Shoulder seams 6a and 6b extend from armholes 3a and 3b to neck opening 5. Left front panel 7 and right front panel 89 are constructed from two-ply of fire resistant fabric. The plies are stitched together at the neck opening 5, the shoulder seams 6a and 6b, at the bottom edges 9 and 10 and around the armholes 3a and 3b. The sleeves 2a and 2b, as well as the collar 4, and the back of the shirt (not shown) are constructed of a single ply and not necessarily of fire resistant fabric. A principal purpose of the invention is to provide the two-ply of fire resistant fabric only where it is needed in the front panels.

FIG. 2, which is a detailed view from the inside of the shirt 1, at point A of FIG. 1, illustrates the bottom ply 7a, and the top ply 8b and how they are folded and sewed at stitch line 12.

FIG. 3, which is a detailed view of shirt 1, at point B of FIG. 1, illustrates the bottom ply 9b, and the top ply 9a and how they are folded in preparation for sewing. A button panel 11, is applied above the abutted edges of plies 9a and 9b, and sewn thereto along stitch lines 13. A strip 14 may be inserted within the button panel 11 to provide additional bulk and strength.

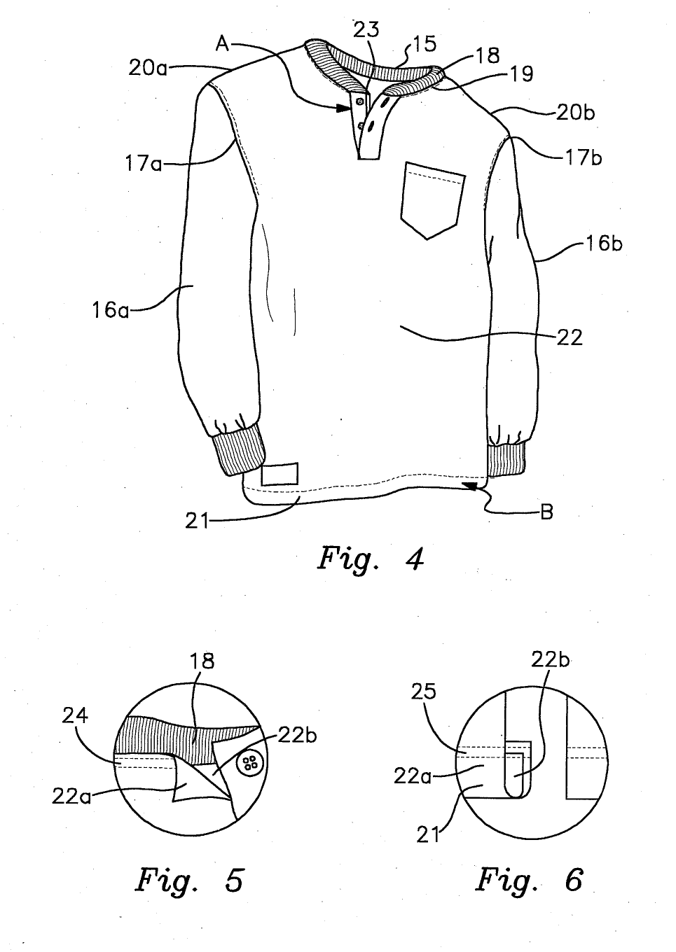

FIG. 4 illustrates another embodiment of the invention. The knit shirt 15 has sleeves 16a and 16b, which extend from armholes 17a and 17b. It has a collar 18 formed above neck opening 19. Shoulder seams 20a and 10b extend from armholes 17a and 17b to neck opening 19. There is a collar 18 formed above the neck opening 19. Shoulder seams 20a and 20b extend from armholes 17a and 17b to neck opening 19. Front panel 22 is constructed from two-ply fire resistant knit fabric. The plies are stitched together at the neck opening 19, the shoulder seams 20a and 20b, at the bottom edge 21 and around the armholes 17a and 17b. The sleeves 16a and 16b, as well as the back (not shown) are constructed of a single ply of fabric and not necessarily fire resistant.

FIG. 5 is a detailed view of collar opening 23, taken at point A. It illustrates the top ply 22a and the bottom ply 22b and how they are sewn to the collar 18 at stitch line 24.

FIG. 6 is a detailed view of the bottom edge 21, taken at point B. It illustrates the top ply 22a and the bottom ply 22b and how they are folded and sewn together along stitch line 25 to form the bottom edge 21.

It will be further apparent to those skilled in the art that various modifications and variations can be made in the device and method of the present invention without departing from the spirit or scope of the invention. Thus, it is intended that the present invention cover the modifications and variations of this invention provided they come within the scope of the appended claims and their equivalents.

1-5. (canceled)

6. A torso-covering garment having a front portion comprising at least two plies of fire resistant fabric, each fire resistant fabric ply having an arc thermal performance value (ATPV) of greater than 4.2 calories square centimeter and a back portion constructed of fabric having an ATPV of equal to or less than 4.2 calories square centimeter.

7. The torso-covering garment of claim 6, which includes sleeves, constructed of fabric having an ATPV of equal to or less than 4.2 calories square centimeter.

8. The torso covering garment of claim 6, which includes a neck opening at the top of said front portion and a hem along the bottom of said front portion; and stitching, around said neck opening and along said hem, which holds together the two or more plies of fire resistant fabric, having an ATPV of greater than 4.2 calories square centimeter, which comprise the said front portion.

9. The torso covering garment of claim 8, wherein the said front portion comprises a left panel and a right panel, which are joined together by overlapping button hole panels; and stitching along said button hole panels which holds together the two or more plies of fire resistant fabric, having an ATPV of greater than 4.2 calories square centimeter, which comprise the said front panels.

10. A torso-covering garment having a front portion comprised of at least two unbonded plies of fire resistant fabric, each fabric ply having an arc thermal performance value (ATPV) of greater than 4.2 calories square centimeter, and a back portion, constructed of fabric having an ATPV of equal to or less than 4.2 calories square centimeter.

11. The torso-covering garment of claim 10, which includes sleeves, constructed of fabric having an ATPV of equal to or less than 4.2 calories square centimeter.

12. The torso covering garment of claim 10, which includes a neck opening at the top of said front portion and a hem along the bottom of said front portion; and stitching, around said neck opening and along said hem, which holds together the two or more unbonded plies of fire resistant fabric, having an ATPV of greater than 4.2 calories square centimeter, which comprise the said front portion.

13. The torso covering garment of claim 12, wherein the said front portion comprises a left panel and a right panel, which are joined together by overlapping button hole panels; and
stitching along said button hole panels which holds together the two or more unbonded plies of fire resistant fabric, having an ATPV of greater than 4.2 calories square centimeter, which comprise the said front panels.
